(19) United States
(12) Patent Application Publication
(10) Pub. No.: US 2010/0110209 A1
(43) Pub. Date: May 6, 2010

(54) FAST MOTION MEASUREMENT DEVICE FOR GAMING

(76) Inventors: John N. Border, Walworth, NY (US); Amy D. Enge, Spencerport, NY (US); James A. Hamilton, Rochester, NY (US); Todd J. Anderson, Fairport, NY (US)

Correspondence Address: Peter P. Hernandez;Patent Legal Staff, Eastman Kodak Company, 343 State Street, Rochester, NY, 14650-2201, US

(21) Appl. No.: 12/262,227

(22) Filed: Oct. 31, 2008

(51) Int. Cl. H04N 5/228

(52) U.S. Cl. 348/222.1; 348/E05.031

(57) ABSTRACT

The invention provides a motion measurement system that is capable of rapid motion measurement of motion that can measure all types of motion including rotational motion, linear motion and motion occurs in the directions of x, y and z. In the motion measurement system of the invention, motion is measured with a high speed image capture and analysis system that captures images of the scene and identifies motion in the scene with a reduced bit rate approach to enable fast data processing.

### FIELD OF THE INVENTION

The present invention generally relates to a dedicated motion sensing measurement system based on an image sensor that is optimized for measurement of fast motions.

### BACKGROUND OF THE INVENTION

Current motion measurement systems for interactive visual systems such as gaming or automatic driving systems rely on gyro-sensing of movement or analysis of video images. Gaming systems such as the Nintendo Wii™ device use a gyro-device to sense motion of the hand held interface. However, this device senses rotational movements and as such does not sense movement which occurs with a constant linear velocity. Automotive movement sensors for collision avoidance rely on analysis of video images as captured at standard video rates such as 30 frames/sec. In many interactive systems, the motion occurs with sections of linear velocity with rapid changes in direction. As a result, a need exists for a motion sensing measurement system that can measure rapid motion of all types with rapid changes in direction.

In U.S. Pat. No. 7,194,126, motion analysis is performed on video images from a stereo image capture system. However, the system is relatively slow due to low sensitivity of the imaging system and high data content in each image resulting in image processing limitations. As a result, the system operates at only 8 frames/sec.

In United States Patent Publication No. 2003/0235327, a method for surveillance is described which is based on object tracking with edge maps to define the shape and location of objects. A number of techniques for generating edge maps are described. In addition, for consumer applications such as interactive gaming and automotive applications, it is desirable to have a motion measurement system that is low in cost and requires low computational power.

United States Patent Publication No. 2006/0146161 discloses a CMOS sensor which has two detectors in each pixel. By operating the pixels so that the two detectors have different exposure times, motion in the image can be detected at each pixel by subtracting the signals from the two detectors.

To provide a motion measurement system that is capable of measuring rapid motion, the present invention discovered that a sensitive imaging system should be combined with image processing that reduces the amount of data that needs to be processed to obtain motion information.

### SUMMARY OF THE INVENTION

It is an object of the present invention to provide a motion measurement system that is capable of measuring motion data at 500 frames/sec or faster. The present invention achieves this rapid processing by using a sensitive imaging system that is combined with an image processing method that substantially reduces the amount of data that must be analyzed in making the motion measurements. The data reduction is provided by converting the captured images into edge maps with 1 bit depth.

A motion measurement system is described with one lens and one imaging sensor for generating x-y motion information.

Another motion measurement system is described with two lenses and two image sensors for generating x-y-z motion information.

A system embodiment is described which includes a sensitive imaging system for use with the motion measurement method of the present invention.

These and other objects, features, and advantages of the present invention will become apparent to those skilled in the art upon a reading of the following detailed description when taken in conjunction with the drawings wherein there is shown and described an illustrative embodiment of the invention.

### ADVANTAGEOUS EFFECTS OF THE INVENTION

The present invention has the advantage of faster image capture, along with reduced data in the images so that the data processing is reduced when obtaining motion measurements. Embodiments are disclosed for obtaining x-y motion measurements and x-y-z motion measurements.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a block diagram of an image capture system of the present invention;

FIG. 2 is a schematic diagram of an image capture device of the present invention with 1 lens and 1 image sensor;

FIG. 3 is a flowchart for an embodiment of the method of the present invention in which an image capture device such as that shown in FIG. 2 is used to generate an x-y motion map;

FIG. 3A is an illustration of an image as captured from a first image capture device of the present invention;

FIG. 3B is an illustration of an image as captured with an object in x-direction translation from first image by the first image capture device;

FIG. 3C is an edge map of the image from FIG. 3A;

FIG. 3D is an edge map of the image from FIG. 3B;

FIG. 4 is a schematic diagram of an image capture device of the present invention with 2 lenses and 2 image sensors;

FIG. 5 is a flow chart for another embodiment of the method of the present invention in which an image capture device such as that shown in FIG. 4 is used to generate an x-y motion map along with a z motion map;

FIG. 5A is an illustration of an image as captured from a first image capture device of the present invention;

FIG. 5B is an edge map of the image from FIG. 5A;

FIG. 5C is an illustration of an image as captured with object in z-direction translation from first image by the first image capture device;

FIG. 5D is an edge map of the image from FIG. 5C;

FIG. 5E is an illustration of an image as captured from a second image capture device of the present invention;

FIG. 5F is an edge map of the image from FIG. 5E;

FIG. 5G is an illustration of an image as captured with object in z-direction translation from first image by the second image capture device of the present invention;

FIG. 5H is an edge map of the image from FIG. 5G; and

FIG. 6 is an illustration of a buffer as can be used to form edge maps.

### DETAILED DESCRIPTION OF THE INVENTION

The present invention provides a motion measurement system that is capable of rapid motion measurement which can measure all types of motion including rotational motion, linear motion and motion occurs in the directions of x-y and x-y-z. In the motion measurement system of the present invention, motion is measured with a high speed image capture and analysis system that captures images of the scene and identifies motion in the scene with a reduced bit rate approach to enable fast data processing.

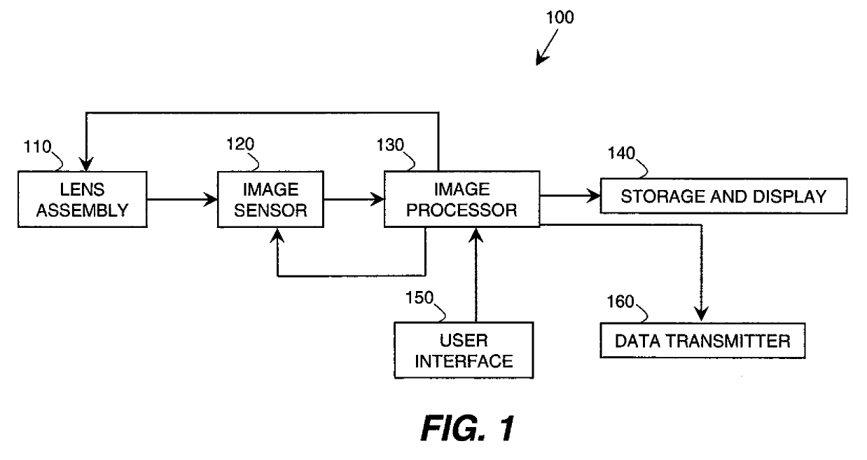

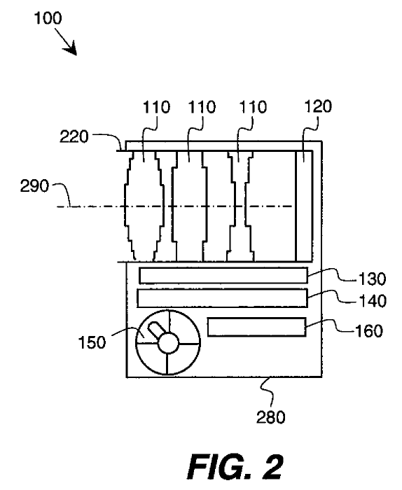

FIG. 1 shows a block diagram of an image capture device 100 of the present invention, such as a digital camera. The lens assembly 110 gathers light from the scene being imaged along an optical axis to produce an image on the image sensor 120. The image sensor 120 has an array of pixels that converts the scene to charge packets and eventually a plurality of signal levels referred to herein as image data. The image data is transmitted to the image processor 130 where the image data is analyzed and improved to form a final image. The final image is sent to storage and/or to a display 140. Alternately, the final image can be sent to the data transmitter 160 for transmission to another device. Based on input from the user interface 150, the image processor 130 can analyze the image differently to determine what capture control signals to send to the lens assembly 110 and the image sensor 120, and how the final image should be handled. Input from the user interface 150 can also determine the method that the image data is sent for storage, display or transmission. FIG. 2 shows a cross sectional schematic diagram of the image capture device for an embodiment of the present invention which includes 1 lens assembly and 1 image sensor. The image capture device 100 includes a lens assembly 110 which gathers light from a scene and presents the light along a common optical axis 290 to an image sensor 120. The lens assembly 110 is mounted inside a barrel 220 (or formed as a stacked device such as in wafer level manufactured lenses) which is mounted in a case 280 along with the image sensor 120, the image processor 130, the storage and display unit 140, and the data transmitter 160. The lens assembly 110 can include fixed or moveable lens elements, a shutter, an iris or an image stabilizer. The image sensor 120 includes an array of pixels. The user interface 150 is shown as a button but the user interface can include a variety of buttons, knobs and touch sensitive devices that the operator can operate. In this embodiment, motion is measured in the directions that are perpendicular to the optical axis 290 of the lens, as in the x, y directions.

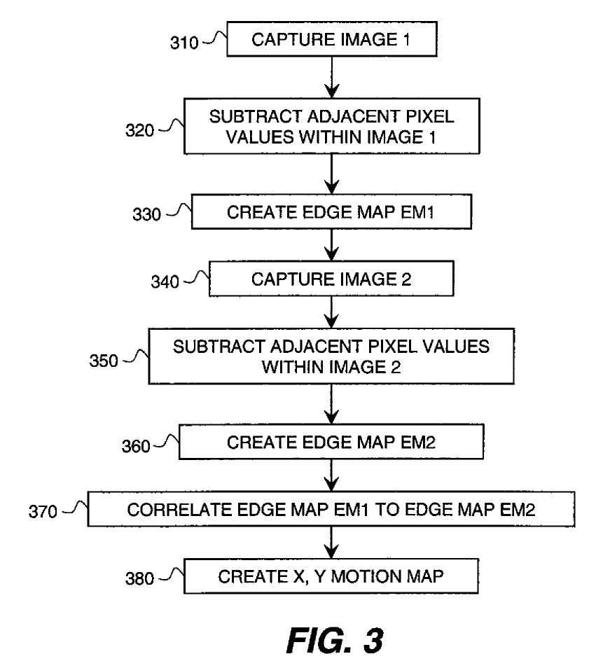

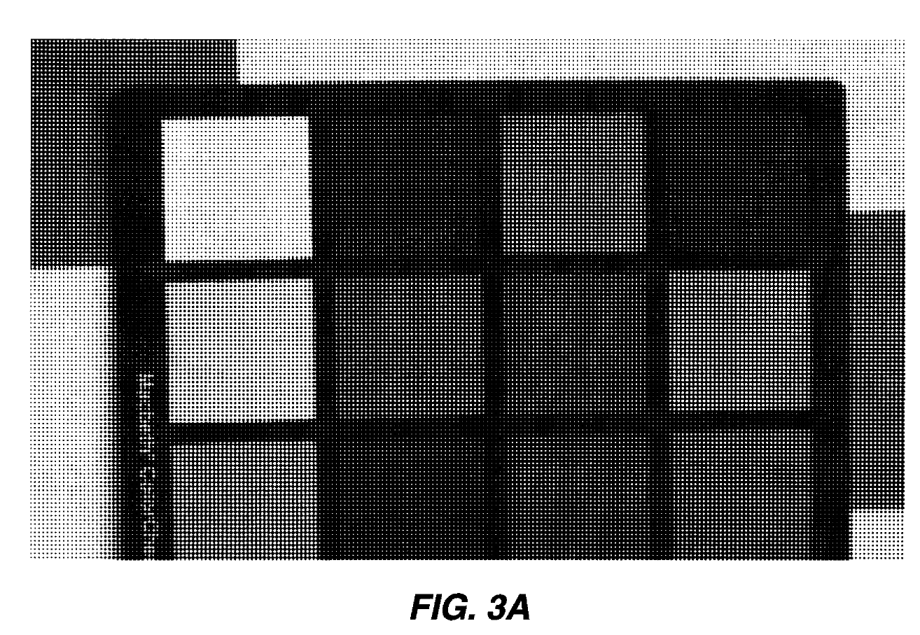

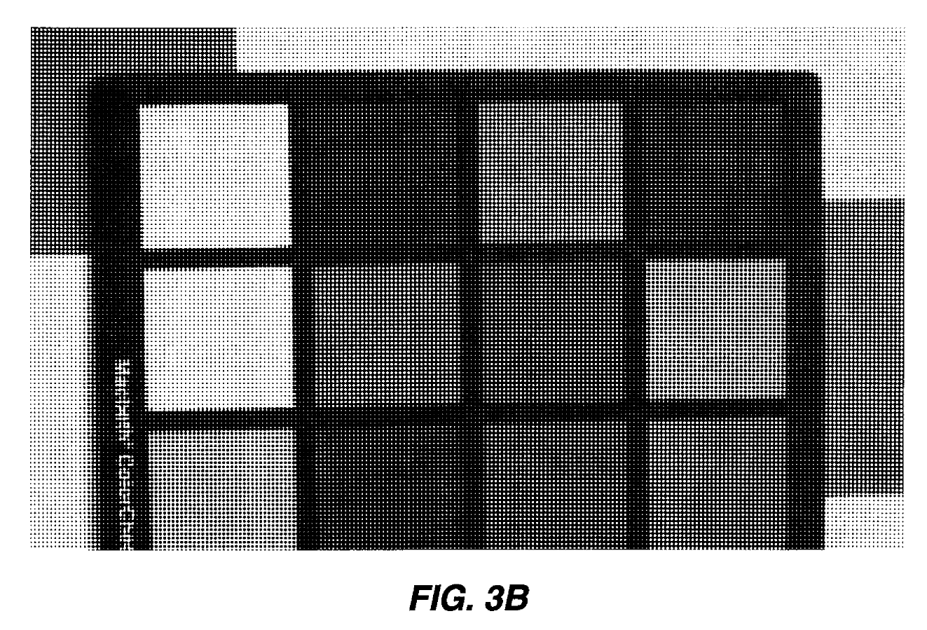

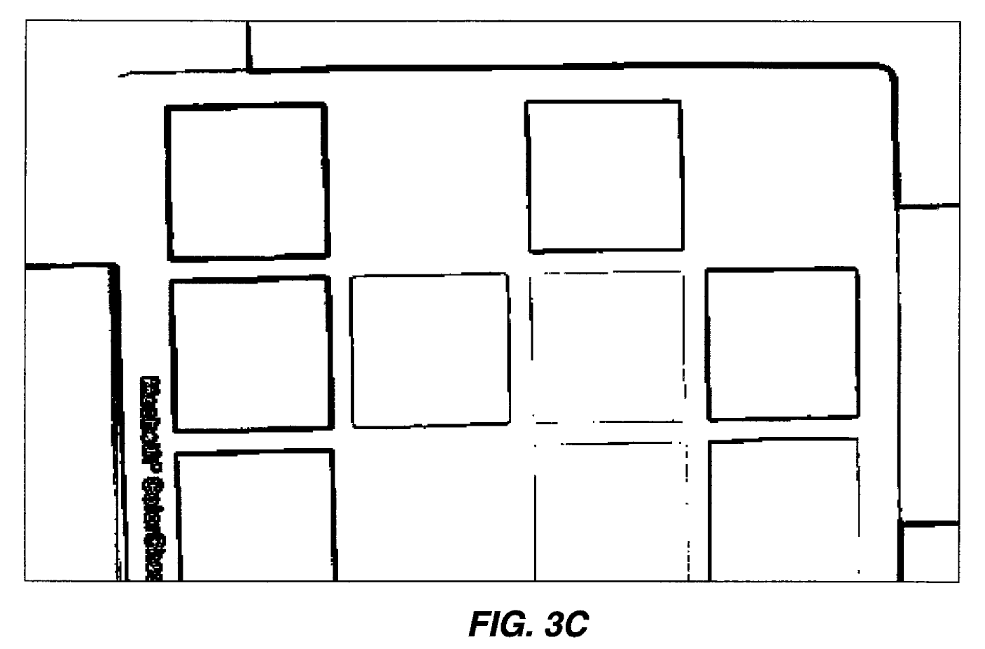

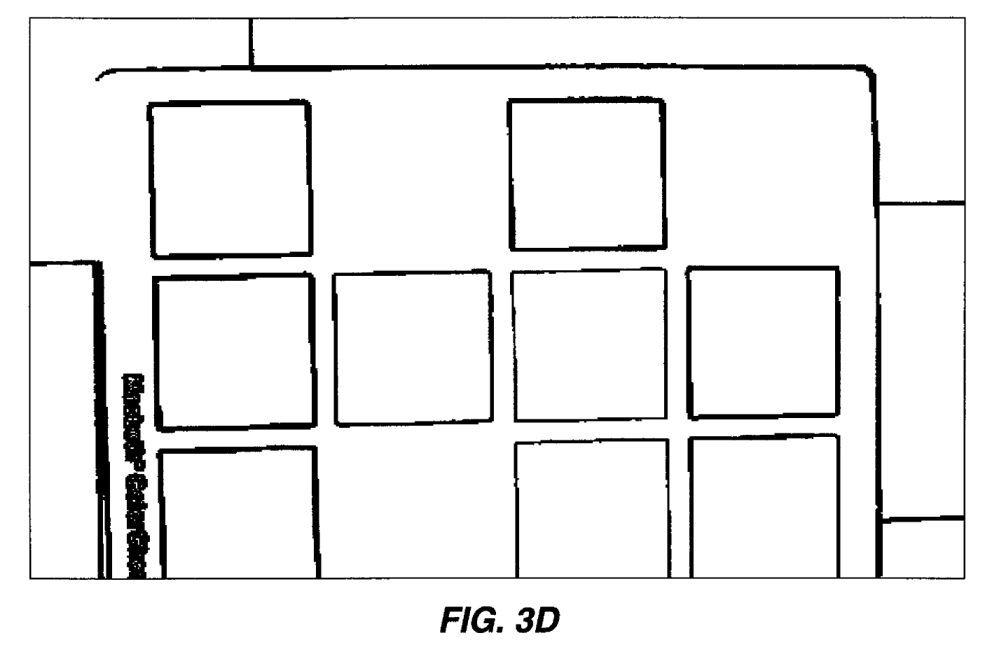

FIG. 3 shows a flow chart for an embodiment of the present invention where x-y motion is measured. In Step 310, a first image is captured by the image sensor 120 wherein the image is designated image 1. An example of image 1 is shown in FIG. 3A. In Step 320, the code value for each pixel in image 1 is subtracted from one or more adjacent pixels in the image processor 130. (The method for subtraction is described herein below.) In Step 330 an edge map EM1 is created in the image processor 130 based on the subtracted values for each pixel, wherein if the subtracted value is less than a threshold value, the pixel is determined to be in a relatively homogeneous region in the image and as such not at an edge, so the value for the pixel in EM1 is set to 0. However, if the subtracted value is greater than a threshold value, the pixel is determined to be located at an edge and the pixel value in EM1 is set to 1. As previously stated, United States Patent Publication No. 2003/0235327 describes a number of methods for generating edge maps. As part of the present invention, the image is converted to an edge map with a bit depth of 1 bit per pixel. By prudently selecting the edge threshold value, much of the data in the image that is attributed to small scale detail such as texture is eliminated so that only larger objects are identified in the edge map and as such the imaging data connected to the small scale detail does not have to be considered for motion measurements. By converting the image to a 1 bit edge map, the amount of data is reduced from a typical 8 or 10 bit depth per pixel to 1 bit which equates to a reduction in the number of bits that must be processed to 1/256 or less. This reduction in the number of bits greatly increases the rate that the images can be processed. An example of EM1 is shown in FIG. 3C. In Step 340, a second image is captured sequentially by the image sensor 120 which is designated image 2. An example of image 2 is shown in FIG. 3B. In Step 350, the code value for each pixel in image 2 is subtracted from one or more adjacent pixels by the image processor 130. In Step 360 an edge map EM2 is created in the image processor 130 based on the subtracted values for each pixel, wherein if the subtracted value is less than a threshold value, the pixel is determined to be in a relatively homogeneous region in the image and as such not at an edge, so the value for the pixel in EM2 is set to 0. However, if the subtracted value is greater than a threshold value, the pixel is determined to be located at an edge and the pixel value in EM2 is set to 1. An example of EM2 is shown in FIG. 3D.

In Step 370, EM1 is correlated to EM2 in the image processor 130 to determine the location and degree of differences between EM1 and EM2. In Step 380, the locations and degrees of difference between EM1 and EM2 are used to create an x-y motion map. The x-y motion is then stored, analyzed for appropriate action or transmitted to another device where the x-y motion is analyzed for appropriate action such as changing the action in an interactive game or causing the brakes to be applied in an automobile. The x-y motion can be converted to x-y velocity by combining the x-y motion and the time between captures of images 1 and 2.

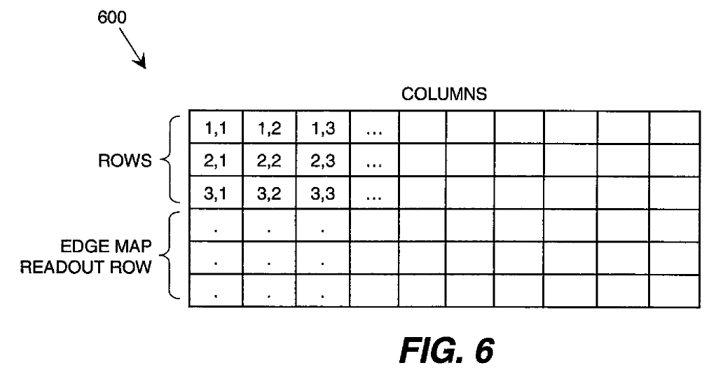

Referring to FIG. 6, the present invention subtracts by storing three consecutive lines from the image into a buffer 600. It is noted that the number of storage units lengthwise of the buffer 600 equals the number of pixels in a row of the image (The number of pixels excludes any non-imaging pixels included on the image sensor, commonly referred to as black pixels.) It is also noted that the locations are identified with the row as the first value of the location and the columns as the second value of the location. For simplicity of illustration, location 2,2 (the kernel location) is used in this example. The image processor 130 retrieves the value at location 2,2 and the locations 2,1; 1,2; 2,3; and 3,2 and does four subtractions. Location 2,2 is subtracted from location 2,1 and is temporarily stored; location 2,2 is subtracted from location 1,2 and is temporarily stored; location 2,2 is subtracted from location 2,3 and is temporarily stored; and location 2,2 is subtracted from location 3,2 and is temporarily stored. All the values in temporary storage are added together and compared to a threshold. If the compared value is greater than the threshold, a value of one is stored in a fourth line of the buffer (edge map readout row) at location 4,2 (In other words, in the 4^{th} row of the buffer and at the column location of the kernel location.) If the compared value is less than the threshold, a value of zero is stored in a fourth line of the buffer at location 4,2 (In other words, in the 4^{th} row of the buffer and at the column location of the kernel location.) This process is repeated for every location until the end of the line is reached and then the fourth row is read out. All the buffer locations are shifted down one row (2,2 goes to location 3,2). The subtraction process is then repeated for every location except the edge locations which are automatically set to zero. Those skilled in the art may readily recognize that other variations of the subtractive process are possible. A subtractive approach is preferred due to its low computational requirements which allows the process to run quickly in the image processor.

Within the scope of the present invention, the image sensor 120 and the image processor 130 can be separate devices or they can be combined on one chip to reduce the cost and size of the image capture device 100. Alternately, aspects of the image processor 130 such as those associated with converting images to edge maps may be included with the image sensor 120 in a single working module which provides edge maps or motion information as along with other information as described below in the invention while other aspects of image processing are done in a separate image processor 130.

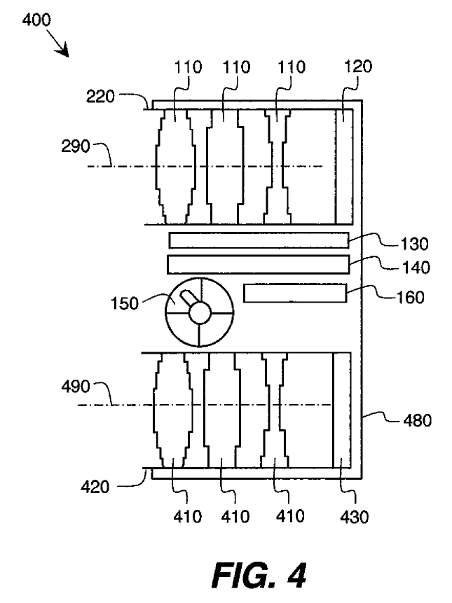

FIG. 4 shows a further embodiment of the present invention in which an image capture device 400 is comprised of 2 lens assemblies and 2 image sensors. Wherein, in addition to the elements shown in common with FIG. 2, a second lens assembly 410 mounted in a barrel 420 gathers light from a scene and presents the light along a second optical axis to the second image sensor 430. The image capture device 400 is mounted in an enclosure 480. The optical axis 290 of lens assembly 110 is separated by a distance (such as 5 to 100 mm) from the optical axis 490 of lens assembly 410 so that images captured by image sensors 120 and 430 have different perspectives of the scene being imaged.

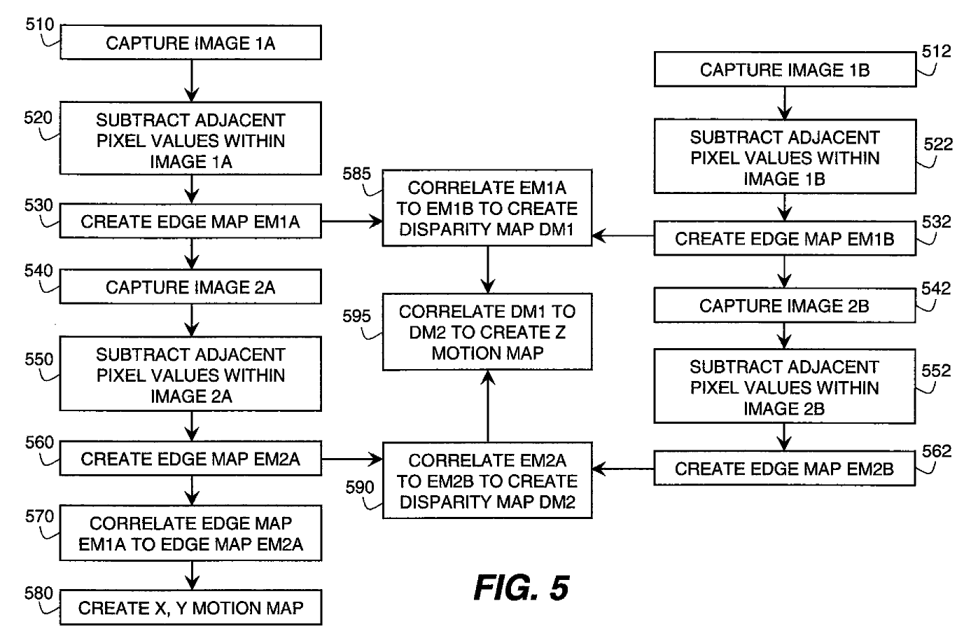

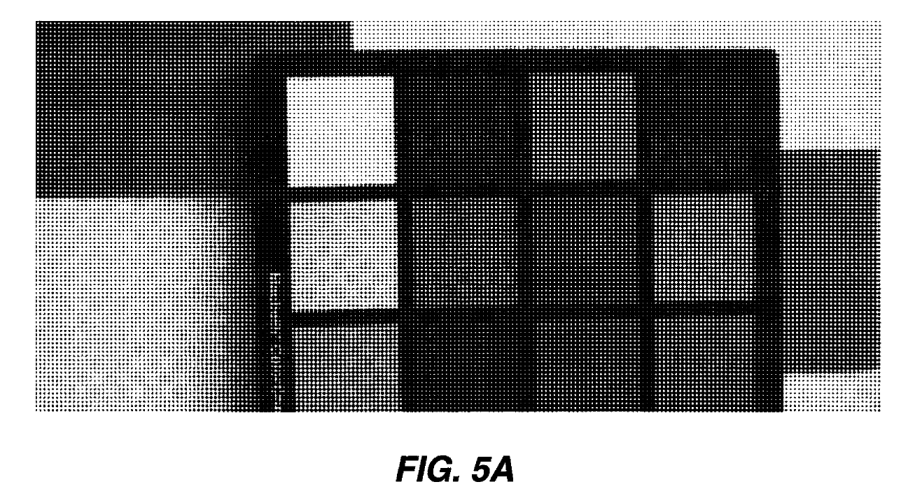

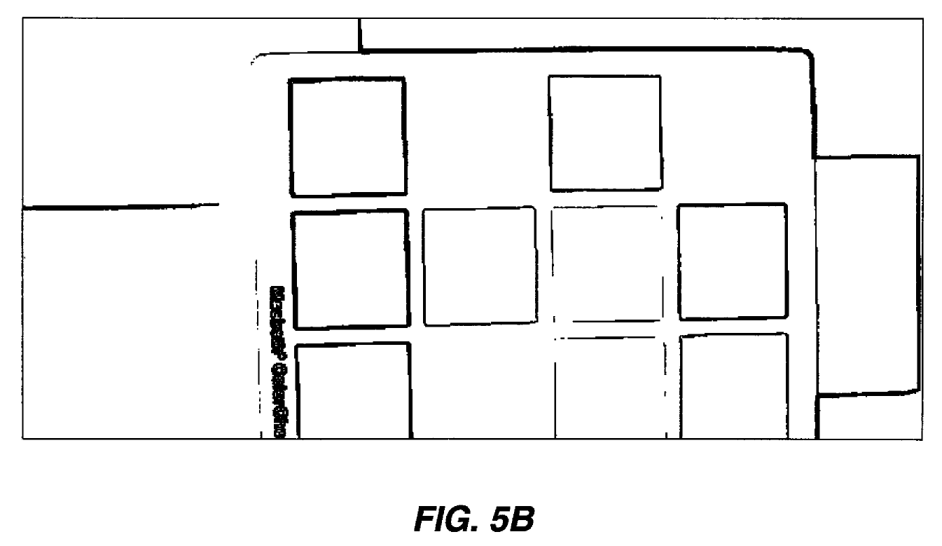

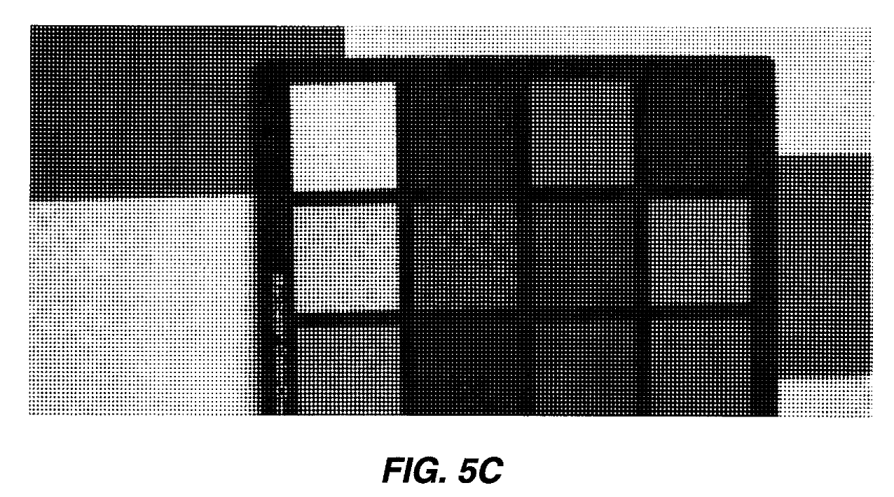

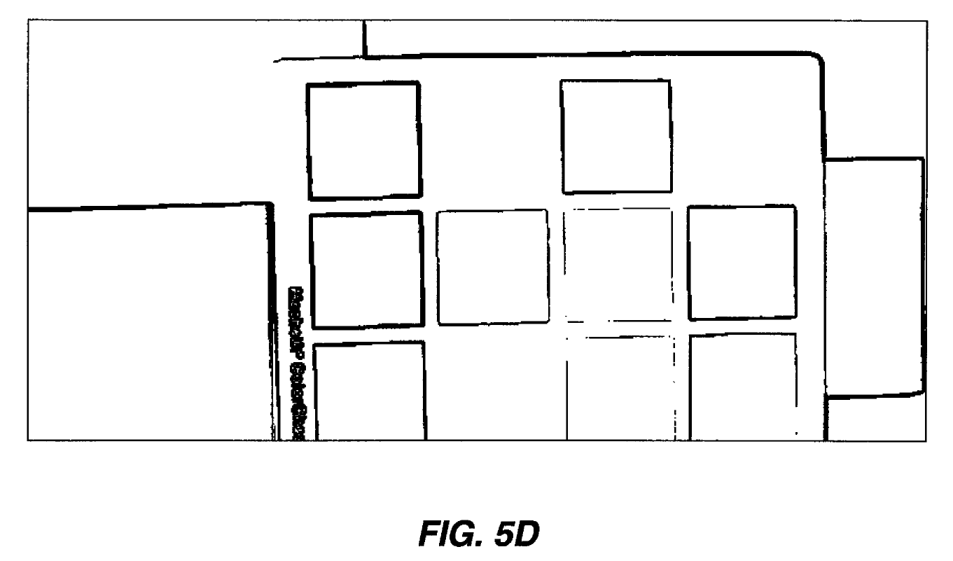

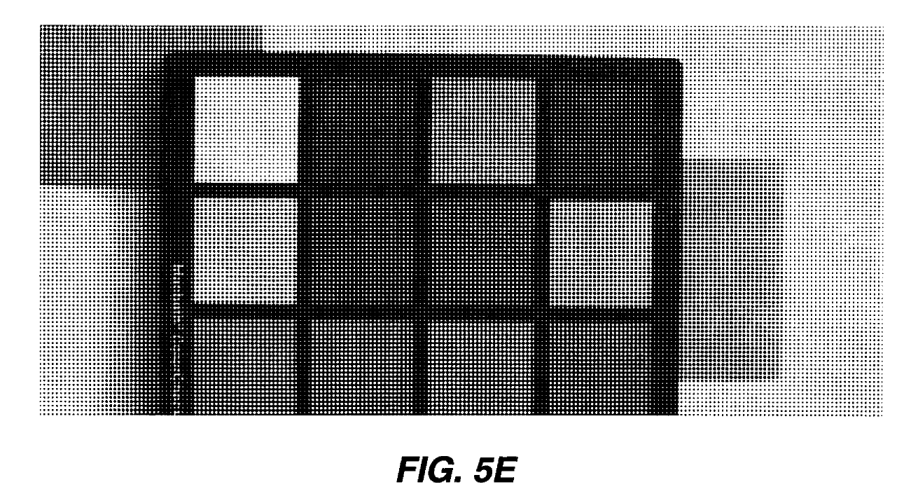

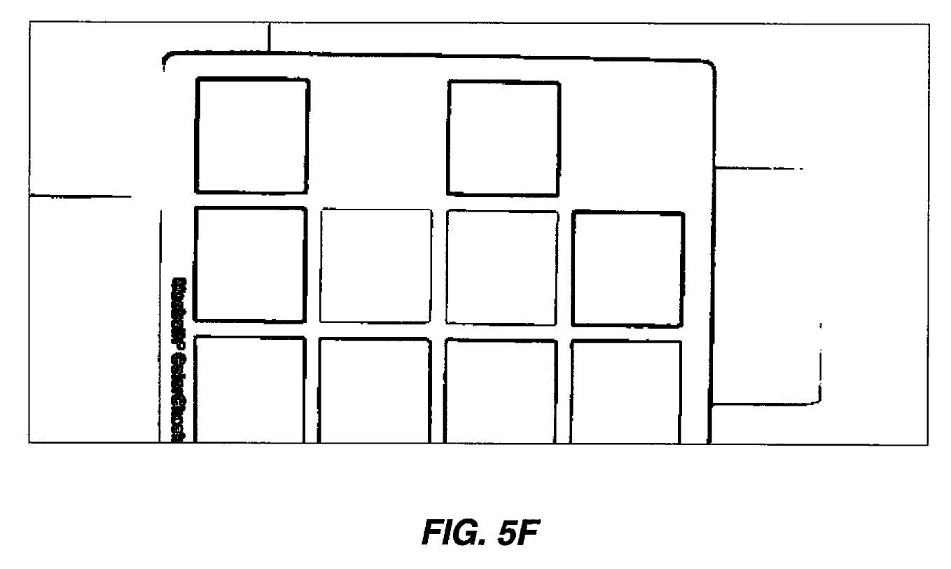

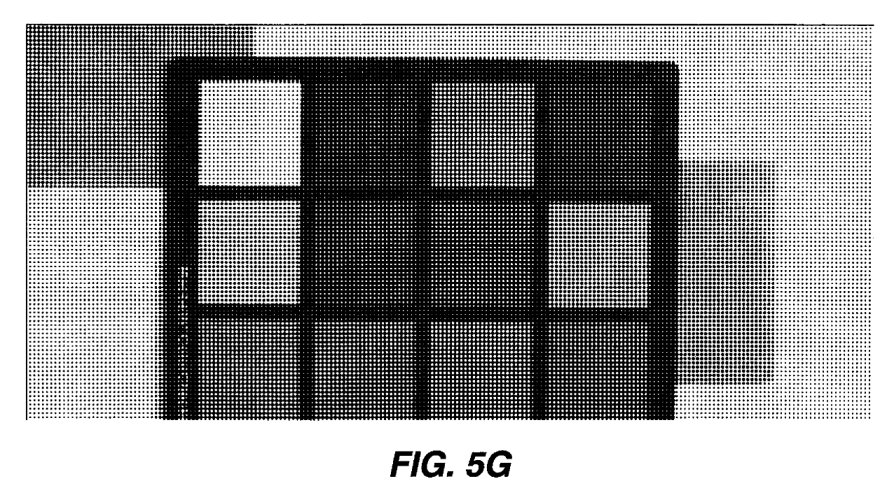

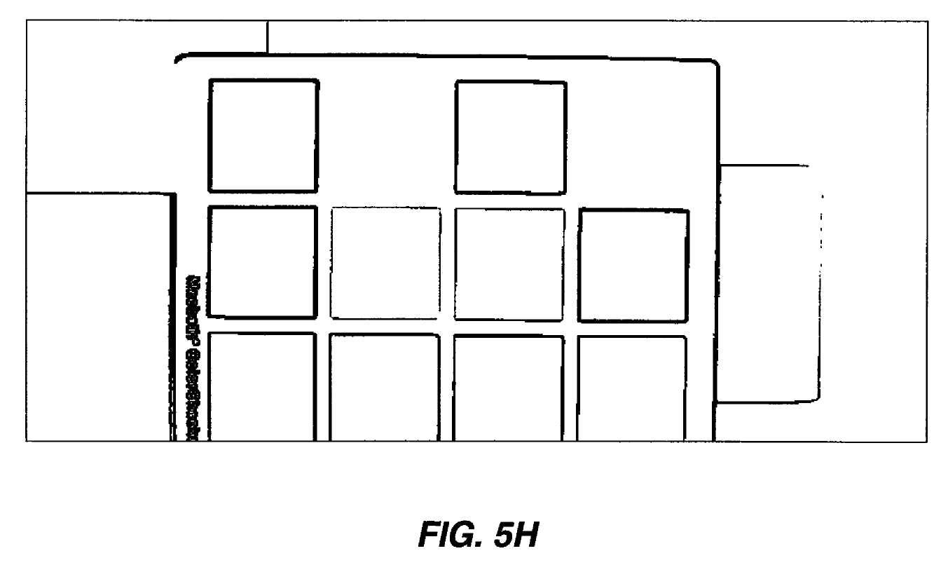

FIG. 5 shows a flow chart for another method which is an embodiment of the present invention in which a motion map with x-y-z motion is created. In Step 510, a first image is captured by image sensor 120 wherein the image is designated image 1A. An example of image 1A is shown in FIG. 5A. In Step 520, the code value for each pixel in image 1A is subtracted from one or more adjacent pixels in image processor 130. In Step 530 an edge map EM1A is created in the image processor 130 based on the subtracted values for each pixel, wherein if the subtracted value is less than a threshold value, the pixel is determined to be in a relatively homogeneous region in the image and as such not at an edge, so the value for the pixel in EM1A is set to 0. However, if the subtracted value is greater than a threshold value, the pixel is determined to be located at an edge and the pixel value in EM1A is set to 1. An example of image EM1A is shown in FIG. 5B.

In Step 540, a second image is captured sequentially by the image sensor 120 which is designated image 2A. An example of image 2A is shown in FIG. 5C. In Step 550, the code value for each pixel in image 2A is subtracted from one or more adjacent pixels by image processor 130. In Step 560 an edge map EM2A is created in the image processor 130 based on the subtracted values for each pixel, wherein if the subtracted value is less than a threshold value, the pixel is determined to be in a relatively homogeneous region in the image and as such not at an edge, so the value for the pixel in EM2A is set to 0. However, if the subtracted value is greater than a threshold value, the pixel is determined to be located at an edge and the pixel value in EM2A is set to 1. An example of image EM2A is shown in FIG. 5D.

In Step 570, EM1A is correlated to EM2A in the image processor 130 to determine the location and degree of differences between EM1A and EM2A. In Step 580, the locations and degrees of difference between EM1A and EM2A are used to create an x-y motion map. By combining the x-y motion map with the time between captures of images 1A and 2A, the x-y velocities for objects in the scene can be calculated.

In Step 512, a first image is captured by image sensor 430 wherein the image is designated image 1B. An example of image 1B is shown in FIG. 5E. Preferably Step 512 is performed substantially simultaneously with Step 510 so that the motion and lighting present during the capture of image 1A and image 1B is substantially the same. In addition, the photographic conditions such as exposure time and iris setting should be substantially the same for image 1A and image 1B so the images look substantially the same. In Step 522, the code value for each pixel in image 1B is subtracted from one or more adjacent pixels in the image processor 130. In Step 532 an edge map EM1B is created in the image processor 130 based on the subtracted values for each pixel, wherein if the subtracted value is less than a threshold value, the pixel is determined to be in a relatively homogeneous region in the image and as such not at an edge, so the value for the pixel in EM1B is set to 0. However, if the subtracted value is greater than a threshold value, the pixel is determined to be located at an edge and the pixel value in EM1B is set to 1. An example of image EM1B is shown in FIG. 5F.

In Step 585, EM1A is correlated to EM1B to create a disparity map DM1 which shows the differences in locations of objects in EM1A and EM1B due to their respective different perspectives. Wherein the disparity map shows the pixel shifts needed to get the edges of like objects in EM1A and EM1B to align. By calibrating the image capture device for measured disparity value vs z location, the disparity values in the disparity map can be used to calculate z locations by triangulation along with the separation between the optical axes of lenses 110 and 410. A discussion of methods to produce rangemaps and disparity maps for the purpose of autofocus, improved image processing and object location mapping can be found in U.S. patent application Ser. No. 11/684,036.

In Step 542, a second image is captured sequentially by image sensor 430 which is designated image 2B. An example of image 2B is shown in FIG. 5G. Step 542 is preferably performed at substantially the same time as Step 540 so that image 2A and image 2B have substantially the same motion and lighting present during the capture of the images. In addition, the photographic settings such as exposure time and iris setting should be the same so that image 2a and 2B look substantially the same. In Step 552, the code value for each pixel in image 2B is subtracted from one or more adjacent pixels by image processor 130. In Step 562 an edge map EM2B is created in image processor 130 based on the subtracted values for each pixel, wherein if the subtracted value is less than a threshold value, the pixel is determined to be in a relatively homogeneous region in the image and as such not at an edge, so the value for the pixel in EM2B is set to 0. However, if the subtracted value is greater than a threshold value, the pixel is determined to be located at an edge and the pixel value in EM2B is set to 1. An example of image EM2B is shown in FIG. 5H.

In Step 590, EM2A is correlated to EM2B to create a disparity map DM2 which shows the differences in locations of objects in EM2A and EM2B due to their respective different perspectives.

In Step 595, DM1 is correlated to DM2 to identify differences between the disparity maps based on z motion and produce a z motion map. The z motion information is then stored, analyzed for appropriate action or transmitted to another device where the z motion is analyzed for appropriate action. The benefit provided by reduced image processing needs is similar to that given for the previous embodiment since the data is again reduced from 8 or 10 bit depth to 1 bit depth.

By combining the change in disparity for each pixel with the time between image captures for images 1A and 2A (which should be substantially the same time as the time between captures for images 1B and 2B), the z velocities for objects in the images can be calculated.

While the invention is preferentially described as converting images to a 1 bit edge maps for motion measurement, those skilled in the art will recognize that the goal of the invention is to greatly reduce the number of bits associated with each image so that faster motion measurement is possible, however there may be conditions where a 2 bit or more edge map will enable a better interpretation of the edge map while still providing a substantial reduction in the number of bits associated with the images.

In a system embodiment of the present invention, the above method is used within a system that includes a sensitive imaging system, wherein the lens assemblies 110 and 410 have been improved to increase the amount of light that is gathered from the scene by using a lens that has an f# of 3.0 or less. The lens can have a fixed focal length to reduce costs or it can have a variable focal length to provide more flexible imaging capabilities. The lens can have a focus setting that is fixed to further reduce costs and to improve the accuracy of the calibration for triangulation and eliminate the need to autofocus or the lens can have an autofocus system. Similarly, the image sensors 120 and 430 can be improved to increase the efficiency of converting the image from the lens to image data. An image sensor with panchromatic pixels which gather light from substantially the full visible spectrum can be used. In addition, the image sensor can be operated without an infrared filter to extend the spectrum that light is gathered into the near infrared. Image sensors with larger pixels provide a larger area for gathering light. The image sensors can be backside illuminated to increase the active area of the pixels for gathering light and increase the quantum efficiency of the pixels in the image sensors. Finally for operation where the moving objects to be measured are within approximately 15 feet of the image capture device, an infrared light can be used to supply illumination to the scene.

As an example, compared to an image capture device with an f# 3.5 lens and a standard front side illuminated Bayer image sensor with 2.0 micron pixels and an infrared filter and no illumination from the image capture device, a preferred embodiment of the invention would include: an f#2.5 (or less) lens; a fixed focal length which has a field of view that is just wide enough to image the desired scene; a fixed focus setting in the middle of the depth of the desired scene (in absence of a prior knowledge of the depth of the scene, the lens should be focused at the hyperfocal length which is the focus setting which provides the largest depth of field); an image sensor with panchromatic pixels; no infrared filter; 4.0 micron pixels; the image sensor is back side illuminated and an infrared light is provided with the image capture device (note that in portable applications, the power consumption of the infrared light may be too large to support with batteries). The benefits of these changes for the preferred embodiment are as follows:
a) An f#2.5 lens gathers 2× the light compared to an f# 3.5 lens.
b) A fixed focal length lens with a non-autofocus focus system (fixed or manually adjustable focus) is much lower cost and time required to autofocus is eliminated.
c) Panchromatic pixels provide 3× the light gathering compared to Bayer pixels.
d) Eliminating the infrared filter provides a 20% increase in available light.
e) 4.0 micron pixels have 4× the light gathering area compared to 2.0 micron pixels.
f) A backside illuminated pixel has 3× the active area and 2× the quantum efficiency of a front side illuminated pixel.
g) An infrared light can provide illumination in an environment that is perceived to be dark by the user.
   Thus, by combining the method of the present invention for measuring x-y motion and x-y-z motion with a sensitive imaging system, a very fast motion measuring system is provided which can operate at over 500 frames/sec.

In a further embodiment of the invention, the image sensor(s) includes panchromatic pixels and color pixels distributed across the image sensor. The panchromatic pixels are readout separately from the color pixels to form panchromatic images and color images. The panchromatic images are converted to edge maps that are subsequently used to measure motion. The color images are stored as color images without being reduced in bit depth. The frame rate of the panchromatic images is faster than the frame rate for the color images, for example, the frame rate of the panchromatic images can be 10× the frame rate of the color images so that fast motion measurements can be obtained at the same time that low noise color images can be obtained.

The present invention has been described in detail with particular reference to certain preferred embodiments thereof, but it will be understood that variations and modifications can be effected within the spirit and scope of the invention.

### PARTS LIST

100 Image capture device
110 Lens assembly block
120 Image sensor block
130 Image processor block
140 Storage and display block
150 User interface block
160 Data transmitter block
220 Barrel
280 Enclosure
290 optical axis
310 Step
320 Step
330 Step
340 Step
350 Step
360 Step
370 Step
380 Step
400 Image capture device with 2 lenses and 2 image sensors
410 Lens assembly
420 Barrel
430 Image sensor
480 Enclosure
510 Step
512 Step
520 Step
522 Step
530 Step
532 Step
540 Step
542 Step
550 Step
552 Step
560 Step
562 Step
570 Step
580 Step
585 Step
590 Step
595 Step
600 Buffer

1. An image capture device comprising:
(a) a lens for directing incoming light along an optical path;
(b) an image sensor captures at least two sequential image frames; and the image sensor receives light from a lens with a common optical axis; and
(c) an image processor receives at least the two sequential image frames from the image sensor and converts each received image frame into one bit edge maps wherein the image processor obtains motion information from analysis of sequential edge maps.

2. The image capture device as in claim 1, wherein the motion information is x-y motion.

3. The image capture device as in claim 1 further comprising one electronic chip which contains the image sensor and the image processor.

4. The image capture device as in claim 1, wherein the image sensor includes panchromatic pixels.

5. The image capture device as in claim 1 further comprising
(a) two lenses which direct incoming light along two optical axes;
(b) two imaging sensors that capture at least two sequential image frames wherein each image sensor receives light from only one of the optical axes; and
(c) an image processor receives at least the two sequential image frames from each image sensor and converts each image frame into one bit edge maps; and wherein the image processor obtains motion information from analysis of sequential edge maps.

6. The image capture device as in claim 5 wherein the motion information is x-y motion or x-y-z motion.

7. The image capture device as in claim 6 further comprising one electronic chip which contains the image processor and at least one image sensor.

8. The image capture device as in claim 5, wherein the image sensor includes panchromatic pixels.

9. A method for obtaining motion information, the method comprising the steps of:
(a) providing optical light on an optical axis;
(b) capturing at least two sequential image frames from an image sensor from the optical axis;
(c) converting the sequential image frames from the image sensor into one bit edge maps; and
(d) using the one bit edge maps to generate motion information.

10. The method as in claim 9, wherein step (d) includes (e) comparing sequential edge maps from the optical axis to generate x-y motion information.

11. A method for obtaining motion information, the method comprising the steps of:
(a) providing light from two optical axes;
(b) capturing at least two sequential image frames from a first image sensor from one optical axis and capturing at least two sequential image frames from a second image sensor from the other optical axis;
(c) converting the sequential image frames from each image sensor into one bit edge maps; and
(d) using the one bit edge maps to generate motion information.

12. The method as in claim 11, wherein step (d) includes (e) comparing sequential edge maps from one of the optical axes to generate x-y motion information.

13. The method as in claim 12 further comprising the step of (f) comparing edge maps from each optical path to generate z location information.

14. The method as in claim 13 further comprising the step of (g) repeating step (f) to generate sequential z location information; comparing the sequential z location information to determine z motion information.

15. The method as in claim 14 further comprising combining results of steps (e) and (g) to generate 3-dimensional motion information.

16. A motion measurement system comprised of:
(a) a lens assembly with a fixed focal length and a non-autofocus focus setting;
(b) an image sensor which includes panchromatic pixels; and
(c) an image processor which can convert sequential images into one bit sequential edge maps and provide x-y motion information from analysis of sequential edge maps.

17. A motion measurement system as in claim 16 wherein the image sensors include color pixels and panchromatic pixels; the panchromatic pixels are readout separately from the color pixels to form panchromatic images and color images; and sequential panchromatic images are converted to one bit edge maps.

18. A motion measurement system as in claim 17 wherein the color pixels are readout to form color images.

19. A motion measurement system comprised of:
(a) Two lens assemblies with a fixed focal length and a non-autofocus focus setting that are separated by a distance;
(b) two image sensors which include panchromatic pixels that respectively receive images from the lens assemblies; and
(c) an image processor which can convert sequential images into one bit sequential edge maps and provide x-y motion information from analysis of sequential edge maps, and in addition produce disparity maps by correlating sequential edge maps and provide z motion information by correlating sequential disparity maps.
